(19) United States
(12) Patent Application Publication
(10) Pub. No.: US 2009/0308327 A1
(43) Pub. Date: Dec. 17, 2009

(54) APPARATUS FOR DISPLACING OBJECTS, AN ASSEMBLY OF SUCH AN APPARATUS AND A STABLE

(75) Inventor: Karel Van Den Berg, Bleskensgraaf (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: MAASLAND N.V., MAASSLUIS (NL)

(21) Appl. No.: 12/088,857

(22) PCT Filed: Sep. 28, 2006
(86) PCT No.: PCT/NL2006/000485

§ 371 Date: Apr. 1, 2008

(30) Foreign Application Priority Data
Oct. 3, 2005 (NL) 1030091

(51) Int. Cl. A01K 29/00; A01K 1/00; B25J 11/00

(52) U.S. Cl. 119/518; 414/222.02; 119/174; 901/50

(57) ABSTRACT

An apparatus for displacing objects. The apparatus comprises a displaceable support and a holding device for holding objects that is fastened to the support (1). The holding device is detachably fastened to the support (1). An assembly of such an apparatus and a stable with a lying area and a walking area for calves and with a treatment place for calves. The holding device is a gripper or a container for holding a calf.

The invention relates to an apparatus for displacing objects according to the preamble of claim 1.

Such an apparatus is known from U.S. patent application 2002/0049522 A1. The apparatus known from this application comprises a multifunctional, mobile apparatus for performing a variety of tasks, such as mowing, vacuum cleaning, scrubbing and the like, on the ground and/or the floor. For this purpose, various work modules are detachably connectable to the mobile apparatus. Although this apparatus functions properly, there is a permanent need for further improvement of such an apparatus.

For this purpose, an apparatus of the above-described type according to the invention comprises the features of the characterizing part of claim 1. Owing to the fact that the holding device is movable in height and is rotatable in a further embodiment, the apparatus is suitable for performing several tasks, such as for example lifting objects, and the like. Besides, owing to the movability in height, and preferably the rotatability, it is possible to treat not only the ground and/or the floor, but preferably also walls, ceilings or horizontal surfaces that are located above (or below) the level of the ground and/or the floor. In this manner both a feed gripper for gripping animal feed from a feed stock and supplying it in a feed trough in a stable, and a cleaning device for cleaning the wall portions adjacent to the ground, that may be contaminated for example by dung, can alternately be fastened to the support, which provides an advantage relative to the known apparatus and a further increased multifunctionality.

In an embodiment of an apparatus according to the invention, the holding device is a device chosen from the group consisting of: a gripping device, a sucking device, a scooping device, a container, a cleaning device with a holder for cleaning liquid, a filling device with a holder for filling material and an electromagnet.

The operation of the apparatus can be automated to a large extent if the support is displaceable in a computer-controlled manner. In particular, the support is movable along a rail. Alternatively, the support is suspended from a rail. Besides, the support can be autonomously displaceable. In some cases it is difficult or even impossible to dispose a rail to which the support can be fastened so as to be displaceable. In order to be able to make use of the holding device also in these cases, in an embodiment of an assembly according to the invention, the rail is provided with an end, the computer control is suitable for controlling the autonomous vehicle, the autonomous vehicle is provided with a rail portion along which the support is displaceable, and the computer control moves the autonomous vehicle and the support in such a way that the support is displaceable from the end of the rail to the rail portion. This means that the holding device is automatically moved from the rail to the autonomous vehicle.

The invention also relates to an assembly of an apparatus according to the invention and a stable with a lying area and a walking area for calves and with a treatment place for calves, characterized in that the holding device is a gripper or a container for holding a calf. The invention also relates to an assembly of an apparatus for displacing objects, the apparatus comprising a support that is displaceable, for example along a rail or autonomously, and a holding device for holding objects that is fastened to the support, and a stable with a lying area and a walking area for calves and with a treatment place for calves, characterized in that the holding device is a gripper or a container for holding a calf. Preferably, the treatment place is a washing place or a collecting place for the calf. In particular, the support is movable to the treatment place in a computer-controlled manner.

The invention also relates to an assembly of an apparatus according to the invention and a milking robot, characterized in that the holding device comprises a cleaning device with a holder for cleaning liquid for cleaning the milking robot. The invention also relates to an assembly of an apparatus for displacing objects, the apparatus comprising a support that is displaceable, for example along a rail or autonomously, and a holding device for holding objects that is fastened to the support, and a milking robot, characterized in that the holding device comprises a cleaning device with a holder for cleaning liquid for cleaning the milking robot. Preferably, the assembly is provided with a filling place for filling the holder for cleaning liquid. In particular, the cleaning device comprises a high-pressure sprayer.

The invention also relates to an assembly of an apparatus according to the invention and a stable with a leg treatment container for animals. characterized in that the holding device comprises a filling device with a holder for filling material for the leg treatment container. The invention also relates to an assembly of an apparatus for displacing objects, the apparatus comprising a support that is displaceable, for example along a rail or autonomously, and a holding device for holding objects that is fastened to the support, and a stable with a leg treatment container for animals, characterized in that the holding device comprises a filling device with a holder for filling material for the leg treatment container. Preferably, the assembly is provided with a filling place for filling the holder.

The invention also relates to an assembly of an apparatus according to the invention and a stable with a leg treatment container for animals. characterized in that the holding device is suitable for holding a leg treatment container. The invention also relates to an assembly of an apparatus for displacing objects, the apparatus comprising a support that is displaceable, for example along a rail or autonomously, and a holding device for holding objects that is fastened to the support, and a stable with a leg treatment container for animals, characterized in that the holding device is suitable for holding a leg treatment container.

The invention also relates to an assembly of an apparatus according to the invention and a milking robot, characterized in that the holding device is suitable for holding tools and/or components for the milking robot. The invention also relates to an assembly of an apparatus for displacing objects, the apparatus comprising a support that is displaceable, for example along a rail or autonomously, and a holding device for holding objects that is fastened to the support, and a milking robot, characterized in that the holding device is suitable for holding tools and/or components for the milking robot.

The invention also relates to an assembly of an apparatus according to the invention and a treatment place for animals, characterized in that the holding device is suitable for holding medicines and the like. The invention also relates to an assembly of an apparatus for displacing objects, the apparatus comprising a support that is displaceable, for example along a rail or autonomously, and a holding device for holding objects that is fastened to the support, and a treatment place for animals, characterized in that the holding device is suitable for holding medicines and the like.

The invention also relates to an assembly of an apparatus according to the invention and a milking robot with a container for separated milk, characterized in that the holding device is suitable for holding the container for separated milk. The invention also relates to an assembly of an apparatus for displacing objects, the apparatus comprising a support that is displaceable, for example along a rail or autonomously, and a holding device for holding objects that is fastened to the support, and a milking robot with a container for separated milk, characterized in that the holding device is suitable for holding the container for separated milk. Preferably, the assembly is provided with a pick-up place containing empty containers for separated milk and/or a deposit place for depositing containers filled with separated milk. In particular, the assembly is provided with a cleaning device for cleaning the containers.

If the holding device is detachably fastened to the support, the assembly is preferably provided with a storage space for containing several holding devices. In particular, the storage space is suitable for containing one or more holding devices chosen from the group consisting of: a gripping device, a sucking device, a scooping device, a container, a cleaning device with a holder for cleaning liquid, a filling device with a holder for filling material and an electromagnet.

The invention will now be explained in further detail with reference to an embodiment as shown in the accompanying drawings, in which

FIG. 1 is a schematic side view of a displaceable support for detachably fastening a holding device to said support;

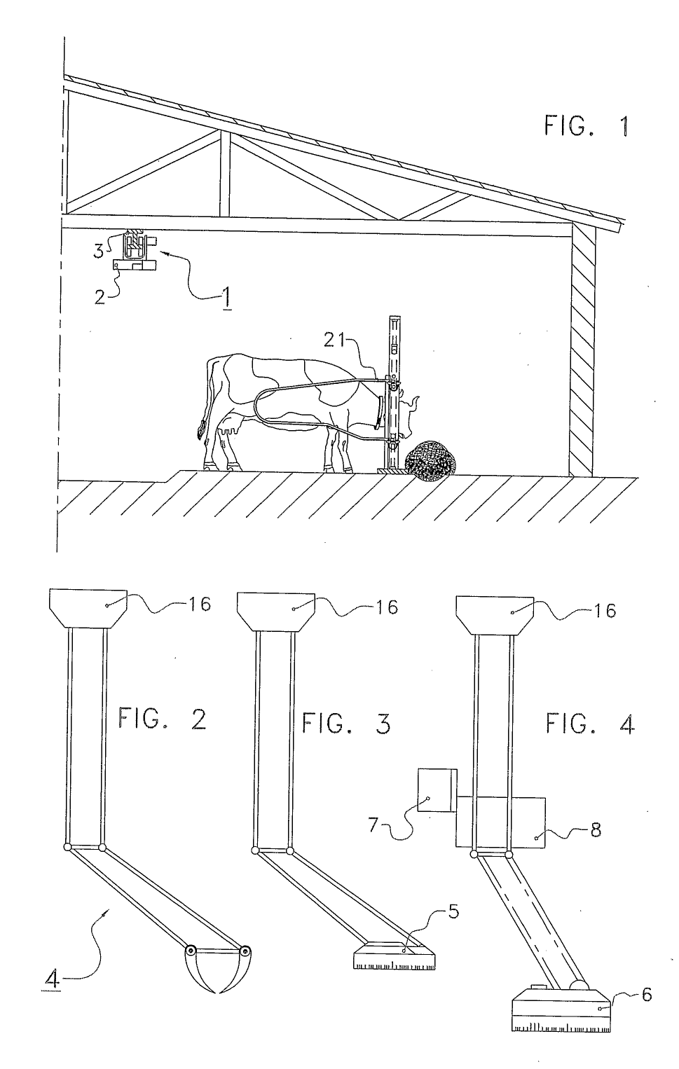

FIG. 2 is a schematic side view of a gripping device as a holding device;

FIG. 3 is a schematic side view of an electromagnet as a holding device;

FIG. 4 is a schematic side view of a sucking device as a holding device;

FIG. 5 is a schematic side view of a scooping device as a holding device;

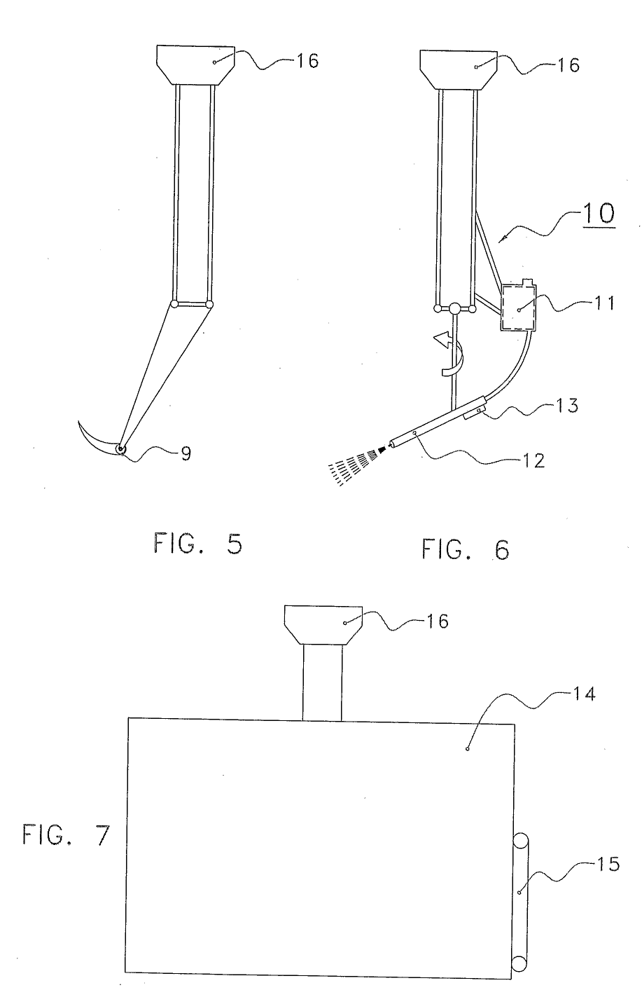

FIG. 6 is a schematic side view of a cleaning device with a holder for cleaning liquid, respectively a filling device with a holder for filling material as a holding device;

FIG. 7 is a schematic side view of a container as a holding device, and

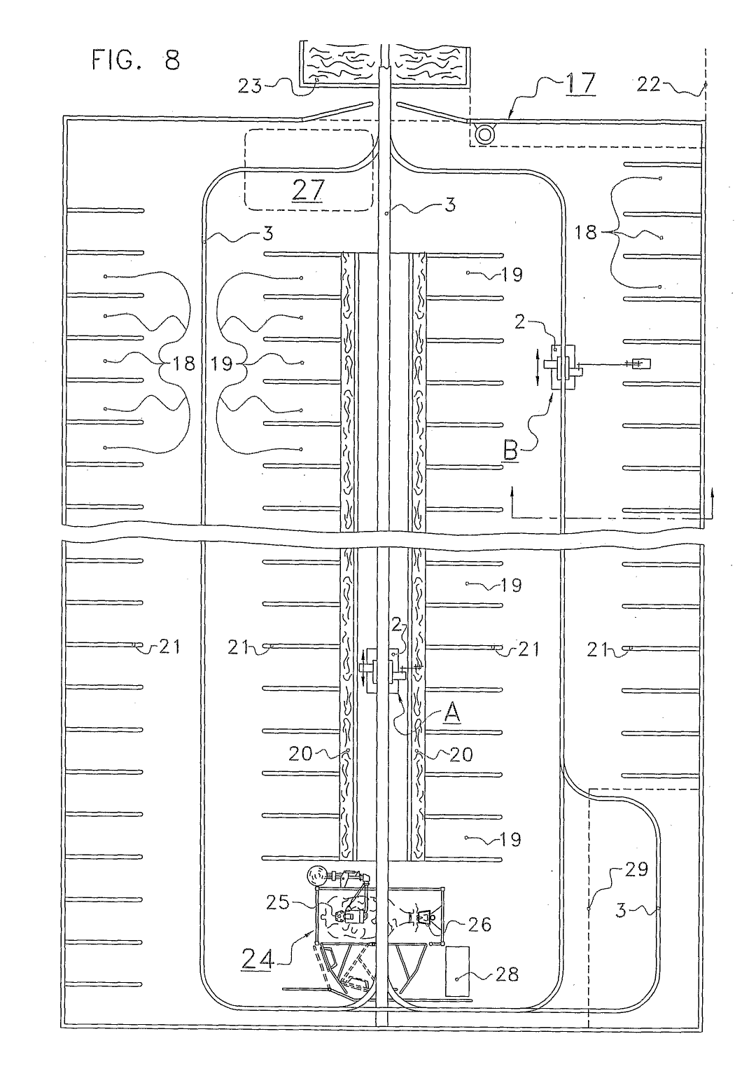

FIG. 8 is a schematic plan view of an assembly of an apparatus according to the invention with a stable and the respective components thereof.

FIG. 1 is a schematic side view of a displaceable support 1 for detachably fastening a holding device to said support. For this purpose, the support 1 is provided with a connecting device 2, such as for example an electromagnet and/or mechanical locking means, for connection to a connecting element of the holding device. In the embodiment shown in FIG. 1, the support 1 is suspended from a rail 3. However, it will be obvious that in an alternative embodiment the support is also movable along a rail, or is autonomously displaceable, the support being provided with means enabling it to move, such as for example wheels.

In FIGS. 2 to 7, various holding devices are schematically shown in side view. FIG. 2 shows a gripping device 4 as a holding device for mechanically gripping, displacing and supplying for example feed, tools, leg treatment containers and the like. FIG. 3 shows an electromagnet 5 as a holding device. The electromagnet 5 is capable of directly holding and releasing objects that are made of appropriate material. If desired, it is possible to accommodate objects, such as medicines, tools, components for a milking robot and the like, in containers or holders, which containers or holders are made of a material that is suitable for being held by means of an electromagnet. In case of a powerful electromagnet, it is even possible to displace a calf or the like in a container. FIG. 4 shows a sucking device 6 as a holding device. The sucking device comprises a pump 7 for sucking material, such as dung, or liquid from a leg treatment container for cleaning and/or disinfecting the legs of an animal. The sucking device 6 is also provided with a collecting reservoir 8 for collecting sucked material. FIG. 5 shows a scooping device 9 for scooping dung, hay and the like and for carrying objects such as tools, components for a milking robot, leg treatment containers and the like, as a holding device. FIG. 6 shows a cleaning device 10 with a holder 11 for cleaning liquid, a spraying device 12 and a pump 13, which can alternatively be used as a filling device with a holder for filling materials as a holding device. The cleaning device 10 can be used for cleaning a milking robot, a stable floor, cubicles and the like. The filling device can be used for example for filling leg treatment containers. FIG. 7 shows a container 14 with an entrance door 15 as a holding device. Each of the holding devices is provided with a relevant connecting element 16 for connection to the connecting device 2 of the support 1.

Although the support 1 and the functioning of the holding device can be controlled manually, for example by remote control, the control is preferably performed in a computer-controlled manner. The holding devices are movable in height and can be designed, if desired, as rotatable ones, as shown in FIG. 6. The movement in height can be achieved, for example, by means of cylinders, or equivalent lifting means, which are controlled by a computer or by remote control. If a particular work module, which is detachably connectable to the support, need not or is not allowed to be moved in height for performing its task, said lifting means can be deactivated or locked. The latter can be performed for example automatically if the support is provided with a computer control with a transmitter/receiver or a device for reading electromagnetic information, or the like, and the relevant module is provided with this electromagnetic information that indicates that the lifting means have to be deactivated or locked. After having read this information, the computer control of the support is able to perform said deactivation or locking. Such a computer control with reading device or transmitter/receiver, or another equivalent device, can be provided on the support and the information on the work module can be used in a passive manner, i.e. only readable, or in an active manner, i.e. actively transmitted by an appropriate transmitting device, for other purposes, in particular the purpose of identification of the work module and/or the tasks to be performed by the work module.

FIG. 8 is a schematic plan view of an assembly of a device according to the invention and a stable 17. The stable 17 is provided on both sides with a row of cubicles 18 and in the middle with two rows of feeding places 19 with feeding passages 20. The cubicles 18 and the feeding places 19 are mutually separated by fencings 21.

Beside the stable 17 there is disposed a dung pit 22 and a feed silo 23. Furthermore, at one end of the feeding places 19 there is arranged a milking robot 24 with the aid of which teat cups 25 can be automatically connected to the teats of an animal to be milked. The milking robot 24 is arranged near a milk box that is provided with an entrance door and an exit door. The milk box further comprises a feed trough 26 in which concentrate can be supplied to the animal. In the stable 17 there are further provided a treatment place 27 for animals, for example a washing place for calves or a collecting place for calves that are sold, and a leg treatment container 28 for cleaning the legs of an animal that leaves the milk box.

In the stable 17 there is further provided a storage space 29 in which the various holding devices are accommodated. The rail 3 extends over the stable 17 and comprises several paths and switches, so that all parts of the stable 17 are accessible for a relevant holding device.

It will be obvious that by taking a particular holding device from the storage space 29 and operating same a corresponding function (carrying, displacing and supplying an object) can be performed. Hereinafter the cleaning of the stable floor and the supply of feed will be described by way of example. Although the assembly according to the invention may comprise several supports, the invention will be described with reference to one single support which, in situation A, carries a feed gripper and, in situation B (occurring at another point of time), carries a cleaning device.

The cleaning device B is suitable for cleaning the stable floor. The cleaning device B comprises an arm structure (FIG. 4) that is movable across the stable 17 along the bottom side of a rail. As shown in FIG. 1, the rail 3 is constituted by an I-section that is fastened to a roof of the stable 17. As shown in FIG. 4, the arm structure comprises a holder with a dung pump. The holder comprises one compartment for dung storage and one compartment for storage of a cleaning and/or spraying and/or disinfecting liquid. At the lower side of the arm structure there is disposed a nozzle for sucking waste material, such as dung. The cleaning device B is designed in such a way that, via one side, cleaning and/or spraying and/or disinfecting liquid can be supplied to the nozzle, whereas, via the other side, dung sucked in can be discharged to the relevant compartment. The nozzle has an almost rectangular form and is provided at its lower side with a row of brush hairs. Near the dung pit 22, the stable is further provided with a dung discharge line that debouches into the dung pit 22. In the dung discharge line there is included a dung pump with the aid of which dung that has been collected in the dung compartment can be pumped away into the dung pit 22.

In situation A, the support 1 carries a feed gripper for picking up roughage. The feed gripper is capable of being used at any desired place of the stable 17 and in particular the supply of feed to the feed trough of the milking robot is mentioned in this context. The feed gripper A also comprises an arm structure that corresponds to a great extent to the arm structure of the cleaning device. The arm structure is provided with a gripper that comprises two curved tines that are pivotable about the axes by means of a (non-shown) cylinder. The gripper is capable of supplying the two feed passages with roughage in a manner known per se, but also serves for provisioning the milking robot.

The invention thus relieves the activities of a farmer, in particular the lifting activities of a farmer. It is thus possible to displace calves, robot components, leg treatment containers, tools, feed, cleaning and disinfecting liquids, containers for separated milk and the like in a simple and automatic manner.

1. An apparatus for displacing objects, the apparatus comprising a displaceable support and a holding device for holding objects that is fastened to the support, the holding device being detachably fastened to the support, wherein the holding device is movable in height.

2. An apparatus as claimed in claim 1, wherein the holding device is rotatable.

3. An apparatus as claimed in claim 1, wherein as a holding device a device is chosen from the group consisting of: a gripping device, a sucking device, a scooping device, a container, a cleaning device with a holder for cleaning liquid, a filling device with a holder for filling material and an electromagnet.

4. An apparatus as claimed in claim 1, wherein the support is displaceable in a computer-controlled manner.

5. An apparatus as claimed in claim 1, wherein the support is movable along a rail.

6. An apparatus as claimed in claim 1, wherein the support is suspended from a rail.

7. An apparatus as claimed in claim 1, wherein the support is autonomously displaceable.

8. An assembly of an apparatus as claimed in claim 1 and a stable with a lying area and a walking area for calves and with a treatment place for calves, wherein the holding device is a gripper or a container for holding a calf.

9. (canceled)

10. An assembly as claimed in claim 8, wherein the treatment place is a washing place or a collecting place for the calf.

11. An assembly as claimed in claim 8, wherein the support is movable to the treatment place in a computer-controlled manner.

12. An assembly of an apparatus as claimed in claim 1 and a milking robot, wherein the holding device comprises a cleaning device with a holder for cleaning liquid for cleaning the milking robot.

13. (canceled)

14. An assembly as claimed in claim 12, wherein the assembly is provided with a filling place for filling the holder for cleaning liquid.

15. An assembly as claimed in claim 12, wherein the cleaning device comprises a high-pressure sprayer.

16. An assembly of an apparatus as claimed in claim 1 and a stable with a leg treatment container for animals, wherein the holding device comprises a filling device with a holder for filling material for the leg treatment container.

17. (canceled)

18. An assembly as claimed in claim 16, wherein the assembly is provided with a filling place for filling the holder.

19. An assembly of an apparatus as claimed in claim 1 and a stable with a leg treatment container for animals, wherein the holding device is suitable for holding a leg treatment container.

20. An assembly of an apparatus for displacing objects, the apparatus comprising a displaceable support and a holding device for holding objects that is fastened to the support, and a stable with a leg treatment container for animals, wherein the holding device is suitable for holding a leg treatment container.

21. An assembly of an apparatus as claimed in claim 1 and a milking robot, wherein the holding device is suitable for holding tools and/or components for the milking robot.

22. An assembly of an apparatus for displacing objects, the apparatus comprising a displaceable support and a holding device for holding objects that is fastened to the support, and a milking robot, wherein the holding device is suitable for holding tools and/or components for the milking robot.

23. An assembly of an apparatus as claimed in claim 1 and a treatment place for animals, wherein the holding device is suitable for holding medicines and the like.

24. An assembly of an apparatus for displacing objects, the apparatus comprising a displaceable support and a holding device for holding objects that is fastened to the support, and a treatment place for animals, wherein the holding device is suitable for holding medicines and the like.

25. An assembly of an apparatus as claimed in claim 1 and a milking robot with a container for separated milk, wherein the holding device is suitable for holding the container for separated milk.

26. (canceled)

27. An assembly as claimed in claim 25, wherein the assembly is provided with a pick-up place containing empty containers for separated milk and/or a deposit place for depositing containers filled with separated milk.

28. An assembly as claimed in claim 25, wherein the assembly is provided with a cleaning device for cleaning the containers.

29. An assembly as claimed in claim 8, wherein the holding device is detachably fastened to the support, and in that the assembly is provided with a storage space for containing several holding devices.

30. An assembly as claimed in claim 29, wherein the storage space is suitable for containing one or more holding devices from the group consisting of: a gripping device, a sucking device, a scooping device, a container, a cleaning device with a holder for cleaning liquid, a filling device with a holder for filling material and an electromagnet.
